(19) United States
(12) Patent Application Publication
(10) Pub. No.: US 2016/0122088 A1
(43) Pub. Date: May 5, 2016

(54) An Applicator

(71) Applicant: Michael Jamison, Johannesburg (ZA)

(72) Inventor: Michael Jamison, Johannesburg (ZA)

(21) Appl. No.: 14/896,103

(22) PCT Filed: Mar. 19, 2014
(86) PCT No.: PCT/ZA2014/000012

§ 371 Date: Dec. 4, 2015

(30) Foreign Application Priority Data
Jun. 6, 2013 (ZA) 2013/04133

(51) Int. Cl. B65D 35/36; B65D 35/46; B65D 35/30; B05C 17/10; B05C 17/005

(52) U.S. Cl. CPC B65D 35/36; B05C 17/10; B05C 17/00586; B05C 17/00583; B65D 35/30; B65D 35/46

(57) ABSTRACT

THIS invention relates to an applicator. More specifically, the invention relates to applicator for containing, dispensing and spreading flowable content onto another object. Although the invention may be used in respect of any flowable content, it is envisaged that the applicator will be used primarily in respect of edible spreads, i.e. butter, margarine, etc. The applicator includes a container for holding flowable content and at least one flattened end on the container for in use spreading flowable content dispensed from the container. The applicator further includes one or more dispensing apertures defined by the container for dispensing flowable content therethrough, wherein the one or more dispensing apertures are located at or near the flattened end of the container, and further wherein the one or more dispensing apertures span, or are spaced relative to one another, along the width of the flattened end.

### BACKGROUND OF THE INVENTION

THIS invention relates to an applicator. More specifically, the invention relates to applicator for containing, dispensing and spreading flowable content onto another object. Although the invention may be used in respect of any flowable content, it is envisaged that the applicator will be used primarily in respect of edible spreads, i.e. butter, margarine, etc.

Packages for containing paste-like substances, and having spreading formations located thereon are known. For example, British patent no. GB124343 takes the form of a collapsible tube-like package (i.e. toothpaste container) having a capped nozzle primary end and a flat sealed secondary end. In use, the paste-like substance is dispensable from the package by removing the cap and squeezing the substance out of the nozzle. The package is then flipped over so that the sealed secondary end may be used as a spreader.

It is therefore an object of the invention to provide, for convenience, an applicator having a spreading formation end and dispensing apertures located proximate thereto such that flowable material is dispensable and spreadable using an easy motion. For hygiene, it is a further object of the invention that the dispensing apertures are sealable when not in use.

It will be appreciated that reference to the term “piston” in this specification will be understood to include to any object fitting closely within, and being movable along, a tube.

### SUMMARY OF THE INVENTION

According to the invention there is provided an applicator including:
a container for holding flowable content;
at least one flattened end on the container for in use spreading flowable content dispensed from the container; and
one or more dispensing apertures defined by the container for dispensing flowable content therethrough, wherein the one or more dispensing apertures are located at or near the flattened end of the container, and further wherein the one or more dispensing apertures span, or are spaced relative to one another, along the width of the flattened end.

The applicator may include a sealing member for engaging the dispensing apertures, the sealing member being movable with respect to the dispensing apertures between a sealed condition, wherein the dispensing apertures are restricted from dispensing content therethrough, and a dispensing condition, wherein the dispensing apertures are capable of dispensing content therethrough.

The sealing member may be in the form of a sticker being adhesively secured to the container over the dispensing apertures in the sealed condition and, in the dispensing condition, displaceable therefrom to expose the dispensing apertures. Preferably, the sticker is a tamper evident sticker. More preferably, the sticker wraps substantially around the container thereby to better secure the sticker thereon in the sealed condition.

In one embodiment, the sealing member is in the form of a sealing body having one or more sealing projections extending outwardly therefrom and being sized and shaped to engage and close corresponding dispensing apertures in the sealed condition, the sealing body and consequently the sealing projections being displaceable from the dispensing apertures thereby exposing and placing them in the dispensing condition.

Furthermore, the sealing body may be hingedly attached to the container and pivotally movable relative thereto between a first position, corresponding with the sealed condition wherein the sealing projections engage and close the corresponding dispensing apertures, and a second position, corresponding with the dispensing condition wherein the sealing body and consequently the sealing projections are displaced from the dispensing apertures thereby to expose and open them.

Alternatively, the sealing body may be an inner wall of the container with the sealing projections extending therefrom internally within the container such that the sealing projections are movable into and out of engagement with the dispensing apertures, or corresponding receiving formations defined on an opposite inner wall of the container upstream of the dispensing apertures.

Preferably, the applicator includes a mechanism for, under a squeezing action, disengaging the projections from the dispensing apertures or corresponding receiving formations to place the applicator in the dispensing condition. More preferably, the disengaging mechanism is a lever mechanism, typically located within the container between the dispensing apertures and the flattened end thereof. In use, a squeezing action may be applied to one end of the lever mechanism such that an opposite end thereof pushes outwardly on an inner surface thereof thereby to disengage the projections from the dispensing apertures or corresponding receiving formations to place the applicator in the dispensing condition.

In another embodiment, the dispensing apertures may be initially sealed, and the sealing projections, in use, may double as cutting formations for firstly cutting open the dispensing apertures and subsequently acting as sealing formations in the sealed condition. Typically, the boundaries demarcating the dispensing apertures are at least partially scored to aid the cutting open of the dispensing apertures.

Preferably, the sealing body comprises a stencil plate located on a surface thereof opposite the surface from which the sealing projections extend; the stencil plate spanning over the width of the spaced sealing projections and adapted for in use for applying a pressure thereof to cut the dispensing apertures. For example, a coin may in use be rubbed back and forth over the stencil plate to distribute a cutting force from the sealing projections to the container thereby to cut the dispensing apertures open.

In yet another embodiment, the sealing member is in the form of a sealing body defining a sealing mouth for engaging the container, the sealing body being movable relative to the container between the sealed condition, wherein the mouth pinches together the walls of the container at a location upstream of the dispensing apertures thereby to restrict flow of content thereto, and the dispensing condition, wherein flow of content towards the dispensing apertures is unhindered.

The sealing body may be slidably movable over the flattened end of the container from one lateral side thereof towards an opposite other such that the sealing body is movable across the width of the flattened end.

Alternatively, the sealing body is slidably movable over the flattened end of the container between an upstream position, corresponding to the sealed condition wherein the sealing mouth pinches together the walls of the container at the location upstream of the dispensing apertures, and a downstream position, corresponding to the dispensing condition wherein the sealing mouth is located downstream of the dispensing apertures, such that the sealing body is movable longitudinally along the container.

The sealing body, whether movable laterally or longitudinally on the container, may be removable from the container in the dispensing condition. It is preferably however that the sealing body is captured on the container so as to prevent the sealing body from being removed entirely from the container. More preferably, one or both opposing axial ends of the sealing body are closed by an end wall or cap.

Although the container may take many different forms, it is preferably that it is a collapsible tube-like container with the flattened end thereof being sealed by welding or crimping. Furthermore, it will be appreciated that the flowable material is dispensable therefrom by applying a squeezing action thereto.

Typically, the applicator includes a piston located within the container and movable therein between the flattened end thereof and a secondary opposite end, the piston capable of being urged in use in a downstream direction toward the flattened end.

Generally, the piston is movable in the downstream direction by applying a squeezing action upstream of the piston. To aid the squeezing action or as an alternative thereto, the piston is biased towards the flattened end of the container by a biasing means, for example, an elastic member.

Preferably, the applicator includes a one-way valve thereby to fill a void, created in use within the container as it is emptied from content, with air so as to aid dispensation of content therefrom and/or to maintain the container in a seemingly filled condition.

The secondary end of the container may be a flattened end, or may comprise a threaded nozzle onto which a cap is receivable. It will be appreciates that the one-way valve may be located on the container at or near the secondary end thereof, or on the cap.

Preferably, the piston is hollow and capable of storing a promotional object therein, for example a toy. More preferably, the piston is spherical in shape.

Typically, the dispensing apertures span, or are spaced relative to one another, in one or more lines being spaced upstream of, and substantially parallel to a terminal edge of the flattened end of the container. The dispensing apertures are preferably any one or more closed loop shapes, and/or one or more singular or crossing linear or curved slits.

The terminal edge of the one or more flattened ends of the container may be linear, curved, smooth and/or castellated.

### BRIEF DESCRIPTION OF THE DRAWINGS

The invention will now be described in more detail, by way of example only, with reference to the accompanying drawings in which:

FIG. 1 is a perspective view of an applicator in accordance with the present invention;

FIG. 2 is a perspective view of the applicator of FIG. 1 in use.

FIG. 3 is a top, zoomed-in view of a sticker-like sealing member for the applicator;

FIG. 4 is a perspective view of a comb-like sealing member for the applicator;

FIGS. 5A & B are cross-sectional side views of the applicator showing a first internally operative sealing member for the applicator;

FIG. 5C is cross-sectional side view of the applicator of FIGS. 5A and 5B showing a disengaging mechanism for placing the dispensing apertures in a dispensing condition;

FIG. 6 is a cross-sectional side view of the applicator showing a second internally operative sealing member for the applicator;

FIG. 7 is a perspective view of the applicator showing a first hinged type sealing member for the applicator;

FIG. 8 is a perspective view of the applicator showing a second hinged type sealing member for the applicator;

FIG. 9 is a perspective view of the applicator showing a first sliding type sealing member for the applicator;

FIG. 10 is a perspective view of the applicator showing a second sliding type sealing member for the applicator;

FIG. 11 is a top view of the applicator including a piston therein;

FIG. 12 is are side view of the applicator of FIG. 11 including a biased piston therein:

FIG. 13 is a perspective view of a disposable single-use embodiment the applicator; and

FIG. 14 are bottom and partial top views of a variety of differently configured flattened ends of the applicator.

### DETAILED DESCRIPTION OF THE DRAWINGS

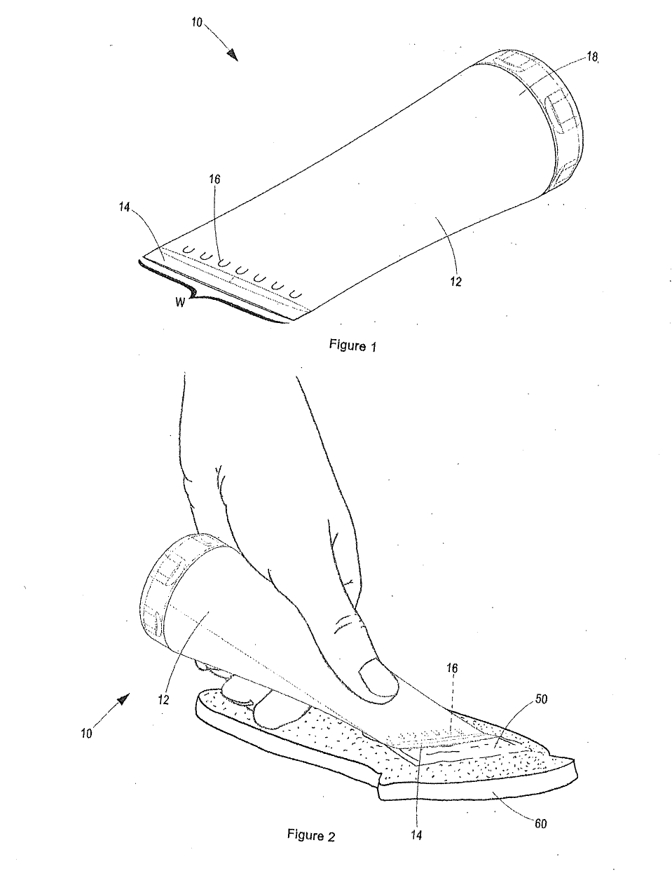

An applicator according to a preferred embodiment of the invention is designated generally in FIG. 1 with reference numeral 10. The applicator comprises a container 12, at least one flattened end 14 and one or more dispensing apertures 16 defined by the container 12 at or near the flattened end 14, the dispensing apertures 16 spanning or being spaced apart relative to one another along the width “W” of the flattened end 14.

The container 12 is a collapsible tube-like container having the flattened end 14 at one end and a secondary capped end 18 at an opposite end. It will be appreciated that the applicator 10 may be used to store and dispense any number of different types of flowable content, one of particular interest being edible spreads such as butter and margarine.

During manufacture and/or filling of the applicators 10, it is envisaged that the container 12 will be filled through an opened end 14 with the flowable content. Once filled, the end 14 will be sealed, typically by welding, to form the flattened end 14.

With reference also to FIG. 2, it will be appreciated that the flattened end 14 doubles in use as a spreader or spatula for spreading flowable content 50 dispensed from the container 12 through the dispensing apertures 16. By applying a squeezing action to the container 12, the flowable content 50 is urged downstream toward the dispensing apertures 16 and dispensable therethrough onto a piece of bread 60 or other object.

Movement of the flattened end 14 over the dispensed flowable content 50 causes the flowable content 50 to be evenly spread by the flattened end 14 over the surface of the bread 60 without the need for a knife or other spreading implement. This enables a user to easy and simultaneously dispense and spread the content 50 using a squeeze and drag action.

Where the flowable content 50 is edible, it will be appreciated that it is essential that the edible content is protected from tampering and becoming contaminated. It is therefore a requirement that the applicator 10, at least when filled with edible flowable content 50, includes a sealing member 20.

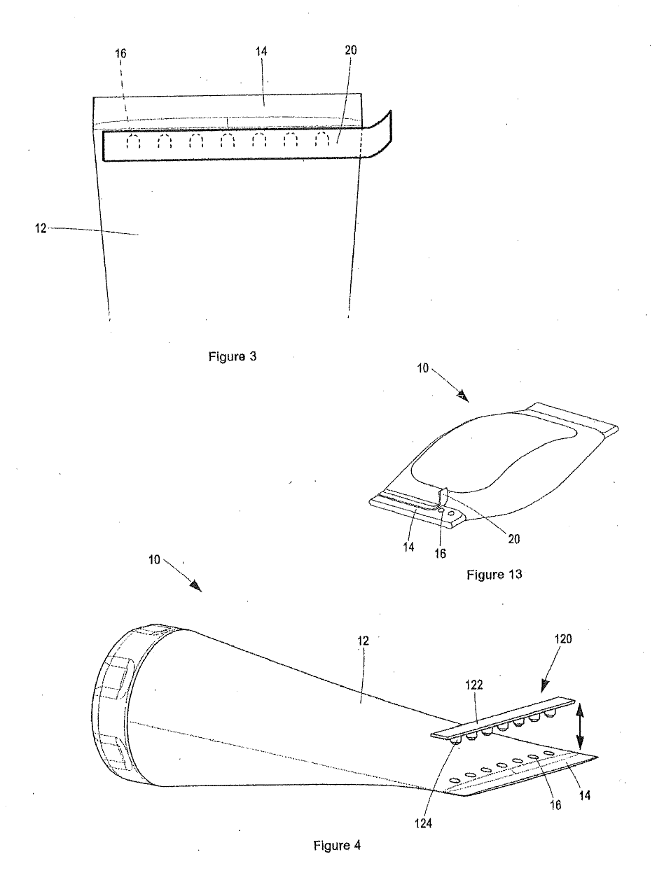

FIG. 3 illustrates a first embodiment of a possible sealing member 20 in the form of a sticker. Preferably, the sticker is a tamper evident sticker 20 adhesively secured to the container 12 and over the dispensing apertures 16 thereby to restrict, in a sealed condition, dispensation from the dispensing apertures 16. Although the sticker 20 in FIG. 3 is shown to span substantially the width “W” of the flattened end 14, it will be appreciated that the sticker 20 may wrap around the container 12 to properly secure the sticker 20 onto the container 12.

To place the dispensing apertures 16 in a dispensing condition, the sticker 20 is removable from the container 12 to expose the dispensing apertures 16 thereby to open the dispensing apertures 16, allowing dispensation of the edible flowable content 50 therethrough.

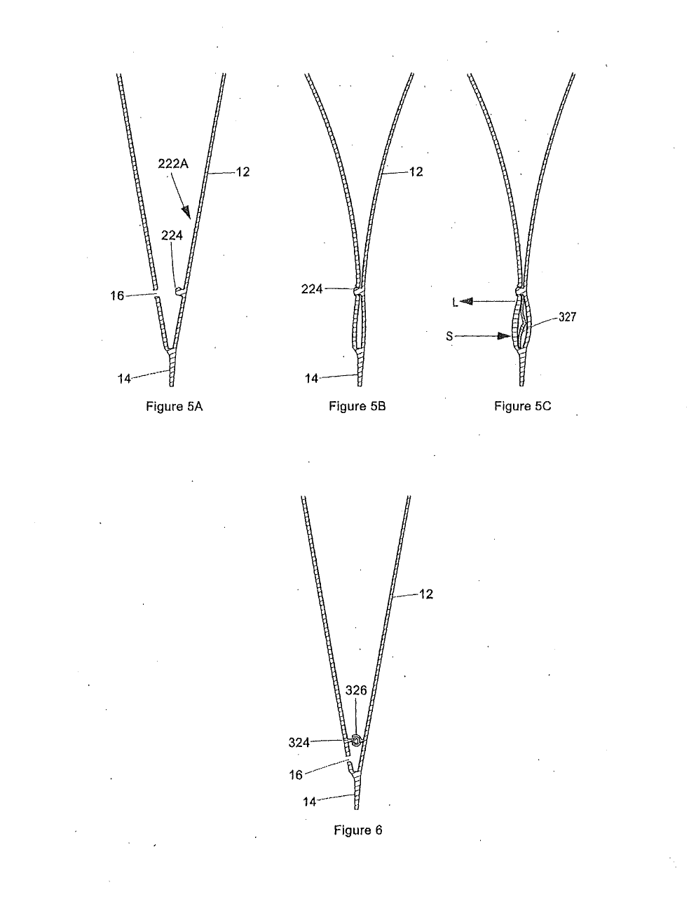

With like reference numerals designating like parts throughout the figures, FIG. 4 illustrates a second comb-like embodiment of a possible sealing member 120 in the form of a sealing body 122 having a one or more sealing projections 124 extending outwardly therefrom, being sized and shaped to engage and close corresponding dispensing apertures 16 in the sealed condition. To place the dispensing apertures 16 in the dispensing condition, the sealing member 120 is displaced from the container 12 so as to disengage the sealing projections 124 from the dispensing apertures 16 thereby to expose and open them.

Where FIG. 4 illustrates an external comb-like sealing member 120, FIG. 5A to 5C illustrates an internal variation thereof, where an internal surface 222A of the container 12 acts as the sealing body with the sealing projections 224 extending internally into the container 12 therefrom. In the sealed condition, the sealing projections 224 engage internally with the dispensing apertures 16, whereas in the dispensing condition the sealing projections 224 are displaced from the dispensing apertures 16 thereby to allow dispensation therethrough.

With reference now to FIG. 6, it will be appreciated that instead of the sealing projections 324 engaging directly with the dispensing apertures 16 to place them in the sealed condition, the sealing projections 324 and corresponding receiving formations 326 could be located upstream of the dispensing apertures 16. In the sealed condition, the sealing projections 324 engage the corresponding receiving formations 326 thereby to restrict flow to the dispensing apertures 16. In the dispensing condition, the sealing projections 324 are displaced from the receiving formations 326 thereby to return flow to the dispensing apertures 16.

In respect of the embodiments illustrated in FIGS. 5 and 6, it is envisaged that having all of the sealing projections disengaging from the dispensing apertures or corresponding receiving formations, simultaneously under a squeezing action for the purposes of placing the dispensing apertures in the dispensing condition, may be quite difficult.

For that reason, it may be useful to incorporate into the applicator a disengaging mechanism in an attempt to as near as possible, disengage the sealing projections from the dispensing apertures or corresponding receiving formations simultaneously.

One embodiment of such a disengaging mechanism is illustrated in FIG. 5C, in the form of a lever mechanism 327 where, in use, a squeezing force “S” applied to one end of the lever mechanism 327 causes an opposite end of the lever mechanism 327 to impart a lifting force “L” to an inner surface of the container 12, thereby to simultaneously place, as far as possible, the dispensing apertures 16 in the dispensing condition.

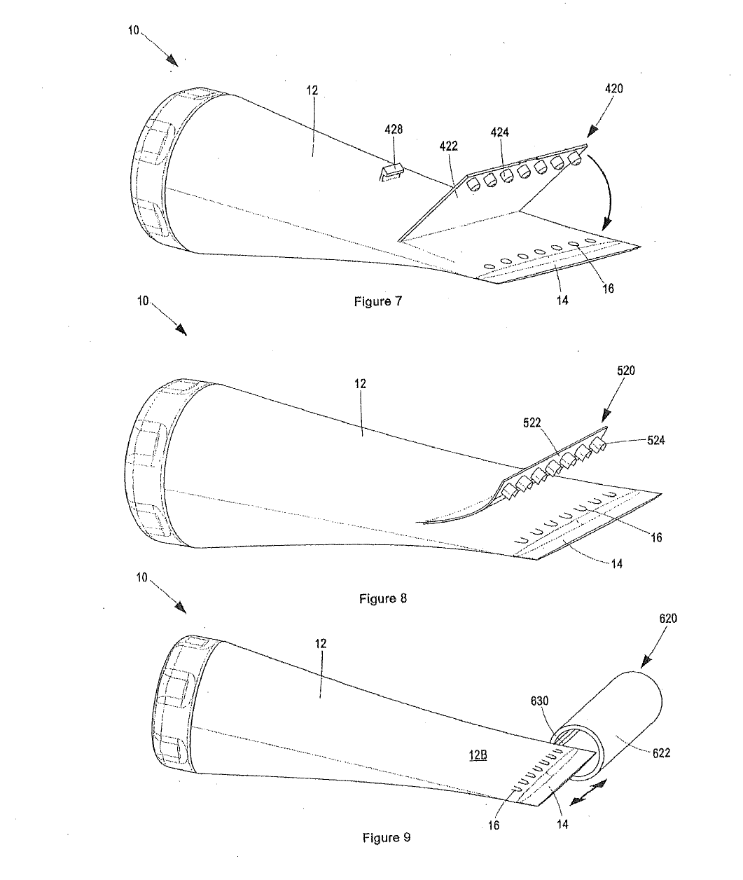

FIG. 7 illustrates a further variance of the comb-like sealing member 120 in the form of a hinged sealing member 420 having a sealing body 422 hingedly attached to the container 12 and pivotally movable relative thereto between a first position, corresponding with the sealed condition, and a second position, corresponding with the dispensing condition.

In the first position, the sealing projections 424 engage and close the corresponding dispensing apertures 16. In the second position, the sealing body 422 and consequently the sealing projections 424 are displaced from the dispensing apertures 16 thereby to expose and open them. It will be appreciated that the hinged sealing member 420 may be releasably retained in the second position by a catch 428.

FIG. 8 illustrates a variation of the embodiment illustrated in FIG. 7. In this embodiment the dispensing apertures 16 are initially non-existent thereby to secure the content inside the container 12 from contamination. The sealing member 520 comprises of a sealing body 522 hingedly attached to the container 12, with sealing-cutting projections 524 extending outwardly therefrom.

In use, the sealing member 520 is urged against the container 12 such that the sealing-cutting projections 524 come into contact with the container 12 to cut open the dispensing apertures 16. Once the dispensing apertures 16 have been cut open, the sealing-cutting projections 524 double as sealing elements, coming into engagement with the dispensing apertures 16 in the sealed condition and displaceable therefrom in the dispensing condition. To aid the cutting open of the dispensing apertures 16, the boundaries or at least portions thereof may be scored.

FIG. 9 illustrates a sealing member 620 comprising a sealing body 622 defining a sealing mouth 630 for slidably engaging the container 12. The sealing body 622 is slidably movable relative to the container 12 between the sealed condition, wherein the sealing mouth 630 pinches together the walls 12B of the container 12 at a location upstream of the dispensing apertures 16 thereby to restrict flow of content thereto. In the dispensing condition, the sealing body 622 is slid laterally (i.e. from one side to the other) across the width of the flattened end 14 and substantially clear from the container 12, thereby to enable flow of content toward the dispensing apertures 16.

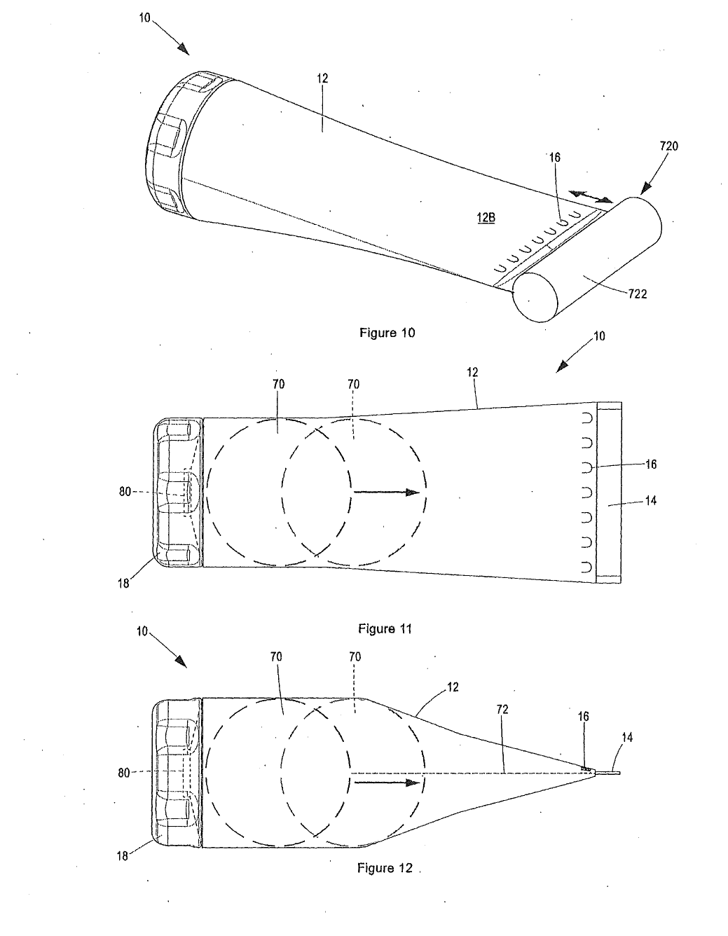

FIG. 10 illustrates a variance of the sealing member 620, comprising a sealing body 720 that, instead of sliding laterally across the flattened end 14 of the container 12, slides longitudinally over the flattened end 14 between a sealed condition, wherein the sealing mouth 730 pinches together the walls 12B of the container 12 at a location upstream of the dispensing apertures 16 thereby to restrict flow of content thereto, and a dispensing condition, wherein the sealing body 722 is moved such that the sealing mouth 730 is located downstream of the dispensing apertures 16 thereby to enable flow of content to the dispensing apertures 16.

The sealing member 620, 720 as illustrated in FIGS. 9 and 10, whether movable laterally or longitudinally on the container 12, may be removable from the container 12 altogether in the dispensing condition, or may be as some position captured thereon so as to prevent the sealing body 622, 722 from being removed entirely from the container 12.

To aid dispensation of the content 50 from the container 12, the applicator 10, in yet another embodiment of the invention as illustrated in FIG. 11, includes a piston 70. The piston 70, spherically shaped or otherwise, is displaceable along the container 12 between the flattened end 14 and the secondary capped end 18, but generally in a downstream direction toward the flattened end 14.

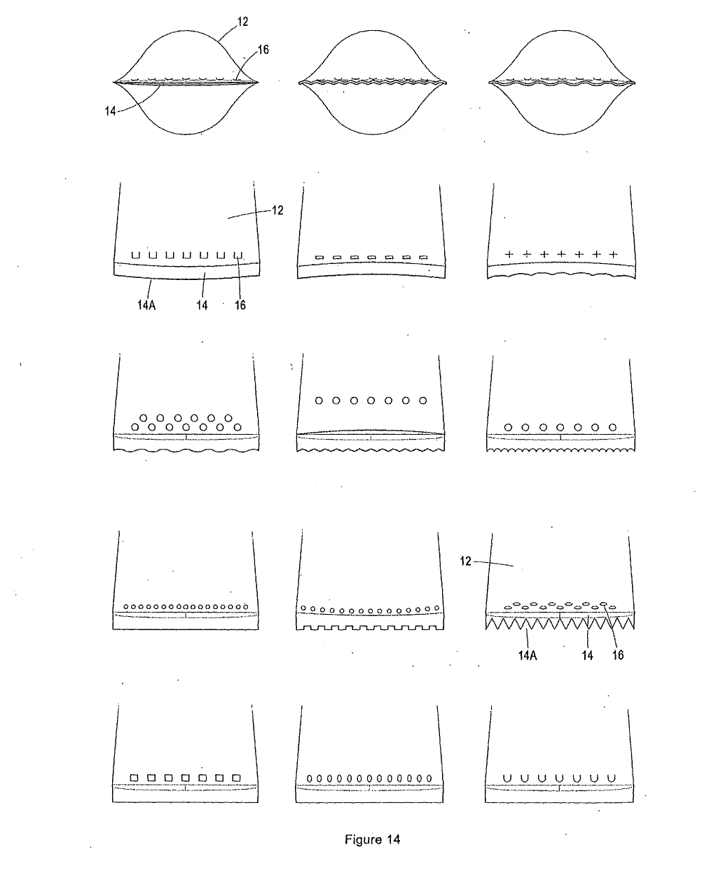

It will be appreciated that the piston 70 is displaceable in the downstream direction along the container 12 by applying a squeezing action to the container 12 upstream of the position of the piston 70. To further urge movement of the piston 70 in the downstream direction, as illustrated in FIG. 12, the piston 70 is biased in such direction by a biasing member 72 acting between the piston 70 and the flattened end 14. The biasing member 72 may be any resiliently deformable member, i.e. an elastic band.

For promotional purposes, it is envisaged that the piston 70 will be hollow and loaded with a promotional object such as a toy. After exhausting the flowable content 50 from the container 12, the container 12 can be cut open to release the piston 70. In turn, the piston 70 can be opened to expose the promotional object stored therein.

Whether the piston 70 is included in the applicator 10 or otherwise, a one-way valve 80 may be incorporated into the applicator 10 to fill a void, created in use within the container 12 as it is emptied from content 50, with air so as to aid dispensation of content therefrom and/or to maintain the container 12 in a seemingly filled condition.

Although the one-way valve 80 has been illustrated as being located in the secondary capped end 18 of the applicator 10, it will be appreciated that the one-way valve 80 may be incorporated into the body of the container 12. In fact, the applicator 10 could, instead of having a secondary capped end 18, have another flattened end as illustrated in FIG. 13, which illustrates what is envisaged to be a disposable, single-use embodiment of the applicator 10 particularly suited to the hospitality industry.

Although the invention has been described above with reference to preferred embodiments, it will be appreciated that many modifications or variations of the invention are possible without departing from the spirit or scope of the invention. For example, FIG. 14 illustrates applicators 10 with a variety of differently configured dispensing apertures 16 and terminal edges 14A of the flattened end 14.

1. An applicator including:
a collapsible tube-like container for holding flowable content;
a spreader on the container for in use spreading flowable content dispensed from the container, the spreader being integral with the collapsible tube-like container and formed by pressing together and sealing walls of the collapsible tube-like container at a primary end thereof to produce a flattened end, which flattened end acts as the spreader; and
one or more dispensing apertures defined by the container for dispensing flowable content therethrough, wherein the one or more dispensing apertures are located at or near the spreader, and further wherein the one or more dispensing apertures span, or are spaced relative to one another, along the width of the spreader;
characterized in that the flattened end is sealed by welding or crimping, with the flowable content being operably dispensable from the dispensing apertures by applying a squeezing action to the collapsible tube-like container.

2. The applicator according to claim 1, including a sealing member for engaging the dispensing apertures, the sealing member being movable with respect to the dispensing apertures between a sealed condition, wherein the dispensing apertures are restricted from dispensing content therethrough, and a dispensing condition, wherein the dispensing apertures are capable of dispensing content therethrough.

3. The applicator according to claim 2, wherein the sealing member is in the form of a sticker being secured to the container over the dispensing apertures in the sealed condition and, in the dispensing condition, displaceable therefrom to expose the dispensing apertures.

4. (canceled)

5. The applicator according to claim 2, wherein the sealing member is in the form of a sealing body having one or more sealing projections extending outwardly therefrom and being sized and shaped to engage and close corresponding dispensing apertures in the sealed condition, the sealing body and consequently the sealing projections being displaceable from the dispensing apertures thereby exposing and placing them in the dispensing condition.

6. The applicator according to claim 5, wherein the sealing body is hingedly attached to the container and pivotally movable relative thereto between a first position, corresponding with the sealed condition wherein the sealing projections engage and close the corresponding dispensing apertures, and a second position, corresponding with the dispensing condition wherein the sealing body and consequently the sealing projections are displaced from the dispensing apertures to open them.

7. The applicator according to claim 5, wherein the sealing body is an inner wall of the container and the sealing projections extending therefrom extend internally within the container such that the sealing projections are movable into and out of engagement with the dispensing apertures, or corresponding receiving formations defined on an opposite inner wall of the container upstream of the dispensing apertures.

8. The applicator according to claim 5 wherein the dispensing apertures are initially sealed, and the sealing projections in use double as cutting formations for firstly cutting open the dispensing apertures and subsequently acting as sealing formations in the sealed condition.

9. The applicator according to claim 8, wherein the boundaries demarcating the dispensing apertures are at least partially scored to aid the cutting open of the dispensing apertures.

10. The applicator according to claim 2, wherein the sealing member is in the form of a sealing body defining a sealing mouth for engaging the container, the sealing body being movable relative to the container between the sealed condition, wherein the mouth pinches together the walls of the container at a location upstream of the dispensing apertures thereby to restrict flow of content thereto, and the dispensing condition, wherein flow of content towards the dispensing apertures is unhindered.

11. The applicator according to claim 10, wherein the sealing body is slidably movable over the spreader from one lateral side thereof towards an opposite other, such that the sealing body is movable across the width of the spreader.

12. The applicator according to claim 10, wherein the sealing body is slidably movable over the spreader between an upstream position, corresponding to the sealed condition wherein the sealing mouth pinches together the walls of the container at the location upstream of the dispensing apertures, and a downstream position, corresponding to the dispensing condition wherein the sealing mouth is located downstream of the dispensing apertures, such that the sealing body is movable longitudinally along the container.

13. The applicator according to claim 10, wherein the sealing body is captured on the container so as to prevent the sealing body from being removed entirely from the container.

14. (canceled)

15. The applicator according to claim 1 including a piston located within the container and movable therein between the spreader and a secondary opposite end, the piston capable of being urged in use in a downstream direction toward the spreader.

16. The applicator according to claim 15, wherein the piston is movable in the downstream direction by at least one of: (i) applying a squeezing action upstream of the piston; and (ii) under the bias of a biasing means.

17. (canceled)

18. The applicator according to claim 1, including a one-way valve thereby in use to fill a void, created in use within the container as it is emptied from content, with air so as to at least one of: (i) aid dispensation of content therefrom; and (ii) to maintain the container in a seemingly filled condition.

19. The applicator according to claim 18, wherein the secondary end of the container is a flattened end formed by pressing together and sealing the walls of the container at the secondary end thereof to produce such flattened end, or comprises a threaded nozzle onto which a cap is receivable.

20. The applicator according to claim 19, wherein the one-way valve is located on the container at or near the secondary end thereof, or on the cap.

21. (canceled)

22. (canceled)

23. The applicator according to claim 1, wherein the dispensing apertures span, or are spaced relative to one another, in one or more lines being spaced upstream of, and substantially parallel to a terminal edge of the spreader.

24. The applicator according to claim 1, wherein the dispensing apertures are at least one of: (i) one or more closed loop shapes; and (ii), one or more singular or crossing linear or curved slits.

25. The applicator according to claim 1, wherein the terminal edge of the spreader of the container is at least one of linear, curved, smooth and castellated.

26. The applicator according to claim 16, wherein the piston is at least one of: (i) spherical in shape; and (ii) hollow for storing a promotional object therein.
